(19) United States
(12) Patent Application Publication
(10) Pub. No.: US 2015/0100895 A1
(43) Pub. Date: Apr. 9, 2015

(54) METHOD OF CUSTOMIZING MULTIMEDIA ATTACHMENT IN ELECTRONIC MAIL AND COMPUTING DEVICE

(71) Applicant: SAMSUNG ELECTRONICS CO., LTD., SUWON-SI (KR)

(72) Inventors: Monil PARMAR, Noida (IN); Manish CHHABRA, Noida (IN)

(73) Assignee: SAMSUNG ELECTRONICS CO., LTD., SUWON-SI (KR)

(21) Appl. No.: 14/294,665

(22) Filed: Jun. 3, 2014

(30) Foreign Application Priority Data
Oct. 8, 2013 (IN) 4560/CHE/2013
Dec. 31, 2013 (KR) 10-2013-0169390

(51) Int. Cl. H04L 12/58; G06F 3/0484; G06F 17/28; G06F 3/0481

(52) U.S. Cl. CPC H04L 51/10; G06F 3/04817; G06F 3/04842; H04L 51/08; G06F 17/289
USPC 715/752

(57) ABSTRACT

A method of customizing a multimedia attachment within an e-mail, and a computing device are provided. The method includes providing an icon, provided so as to receive a user's request for customizing the multimedia attachment, to an e-mail window user interface, receiving the user's request for customizing the multimedia attachment from the user through the icon, and customizing the multimedia attachment in response to the user's request.

### CROSS-REFERENCE TO RELATED APPLICATION(S)

This application claims the benefit under 35 U.S.C. §119(a) of an Indian patent application filed on Oct. 8, 2013 in the Indian Patent Office and assigned Serial number 4560/CHE/2013, and a Korean patent application filed on Dec. 31, 2013 in the Korean Intellectual Property Office and assigned Serial number 10-2013-0169390, the entire disclosures of each of which is hereby incorporated by reference.

### TECHNICAL FIELD

The present disclosure relates to a method of customizing a multimedia attachment in an electronic mail and a computing device.

### BACKGROUND

Electronic mail (email or e-mail) is a method of electronically exchanging a message through a computer network. In general, users have access to web-based e-mail services such as Hotmail™, Yahoo™ mail, Gmail™, or other mail services. Although users may easily transmit a message via e-mail, a multimedia file is often shared as an attachment. The multimedia file includes all types of media content (for example, videos, audio file, texts, and graphics). Typically, users download an attachment in order to view the multimedia file. Users may call an appropriate plug-in downloaded via a web browser which is currently available and may download an attachment.

A user may customize a downloaded attachment by using a general purpose technique that plays an important role. For example, the user may download only audio from an attached video clip or may translate a movie (video or audio) attachment from one language to another language. However, in such a scenario, the user needs to perform customization by using an individual tool. For example, in order to download only audio from an attached video clip, a user needs to download the entire video clip from an e-mail and then extract the audio from the downloaded file by using an individual application tool. In addition, in order for a user to translate a video or audio attachment into another language, the user needs to download the attachment and then translate the audio by using a separate tool. For this reason, the customization of a multimedia attachment is a long and boring operation for many users.

In this regard, there is a need for a method and device capable of customizing a multimedia attachment so that a user may effectively customize the multimedia attachment by using a smart technique.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method of customizing a multimedia attachment, and a computing device.

Additional aspects will be set forth in part in the description which follows and, in part, will be apparent from the description, or may be learned by practice of the presented various embodiments.

In accordance with an aspect of the present disclosure, a method of customizing a multimedia attachment within an e-mail is provided. The method includes providing an icon, via which a user's request may be received for customizing the multimedia attachment, to an e-mail window user interface, receiving the user's request for customizing the multimedia attachment from the user via the icon, and customizing the multimedia attachment in response to receiving the user's request.

In accordance with another aspect of the present disclosure, a computing device that customizes a multimedia attachment within an e-mail is provided. The computing device includes a display device configured to output a user interface, an input device configured to receive a user's input, a communication interface configured to communicate with an external device, a memory configured to stores data processed by a processor, and a processor configured to process the multimedia attachment within the e-mail so as to customize the multimedia attachment. The processor provides an icon, via which a user's request for customizing the multimedia attachment may be received, to an e-mail window user interface, receives the user's request for customizing the multimedia attachment from the user via the icon, and customizes the multimedia attachment in response to receiving the user's request.

In accordance with another aspect of the present disclosure, a computer readable recording medium having embodied thereon is provided. The computer readable recording medium includes a computer program that performs the above-described customizing method.

Characteristics and advantages described in the abstract and the detailed description of the present disclosure, which are to be described later, are not comprehensive. In particular, many characteristics and advantages are obvious to one of ordinary skill in the art from the drawings, the detailed description, and claims. Furthermore, the language used in the detailed description is mainly selected for the purpose of readability and description and is not selected to describe or limit a creative subject. It is necessary to refer to claims in order to determine a creative subject.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an environment in which various embodiments of the present disclosure may be implemented according to an embodiment of the present disclosure;

FIG. 2 is a block diagram of a computing device that customizes a multimedia attachment within an e-mail according to an embodiment of the present disclosure;

FIG. 3 is a diagram illustrating a module which is executed in a processor for customizing a multimedia attachment within an e-mail according to an embodiment of the present disclosure;

FIG. 4 is a diagram showing icons that are provided in a software toolbar of a web browser application so as to receive a request for customizing a multimedia attachment according to an embodiment of the present disclosure;

FIG. 5 is a diagram showing icons that are provided in a web mail user interface so as to receive a request for customizing a multimedia attachment according to another embodiment of the present disclosure;

FIG. 6 is a diagram showing icons that are provided in a web-based e-mail client application so as to receive a request for customizing a multimedia attachment according to another embodiment of the present disclosure;

FIG. 7 is a block diagram showing an attachment editor menu of a software toolbar within a web browser application according to an embodiment of the present disclosure;

FIG. 8 is a block diagram showing an attachment editor menu of a web mail user interface according to another embodiment of the present disclosure;

FIG. 9 is a block diagram showing an attachment editor menu of a web-based e-mail client application according to another embodiment of the present disclosure;

FIG. 10 is a block diagram showing an audio downloading and translation menu according to an embodiment of the present disclosure;

FIG. 11 is a block diagram showing a menu for downloading a video including translated audio according to an embodiment of the present disclosure;

FIG. 12 is a block diagram showing a menu for selectively downloading a clip from a video according to an embodiment of the present disclosure;

FIG. 13 is a block diagram showing a multi-attachment editor menu according to an embodiment of the present disclosure;

FIG. 14 is a flowchart illustrating a method of customizing a multimedia attachment of an e-mail according to an embodiment of the present disclosure;

FIG. 15 is a flowchart illustrating a method of customizing a multimedia attachment of an e-mail according to another embodiment of the present disclosure;

FIG. 16 is a flowchart illustrating a method of extracting only audio from a multimedia attachment according to an embodiment of the present disclosure;

FIG. 17 is a flowchart illustrating a method of extracting and translating audio of a multimedia attachment according to an embodiment of the present disclosure;

FIG. 18 is a flowchart illustrating a method of downloading a video, including a translated audio, from a multimedia attachment according to an embodiment of the present disclosure;

FIG. 19 is a flowchart illustrating a method of extracting only a selected video clip from a multimedia attachment according to an embodiment of the present disclosure; and

FIG. 20 is a flowchart illustrating a method of simultaneously editing a plurality of attachments in a plurality of e-mails according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the detailed description, a method of customizing a multimedia attachment within an e-mail and a computing device will be described in detail. A user may customize a multimedia attachment without using an individual customizing tool by using the method.

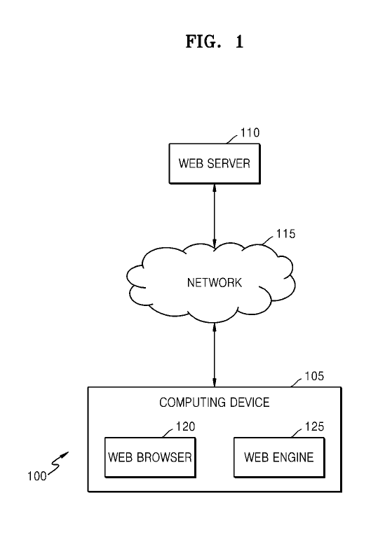

FIG. 1 is a block diagram of an environment 100, and various embodiments can be implemented according to the environment according to an embodiment of the present disclosure.

Referring to FIG. 1, the environment 100 includes a computing device 105, a web server 110, and a network 115. The web server 110 transmits web content (web page) the computing device 105 through the network 115. The computing device 105 and the web server 110 communicate with each other and exchange data with each other through the network 115 (for example, the Internet or a cellular network). Examples of the computing device 105 include a computing device, a laptop, a notebook computer, a tablet device, a smart phone, a Personal Digital Assistant (PDA), and a mobile phone, but the present disclosure is not limited thereto. In addition, the computing device 105 includes a web browser 120 and a web engine 125. A user may access information displayed on a web page via the web browser 120. The web browser 120 may be a desktop web browser (for example, Microsoft Internet Explorer™, Mozilla Firefox™, or Chrome™), a mobile web browser, or a web viewer installed in an application program. In addition, a user retrieves internet information by using the web engine 125.

A user of the computing device 105 may often desire to keep in touch with friends via e-mail. The user may open an e-mail window on the computing device 105 by using the web browser 120. A user may easily locate and retrieve information from the World Wide Web via the web browser 120. In general, the user views an e-mail account through the web browser 120. The e-mail account may contain an e-mail that includes a multimedia attachment. The multimedia attachment integrates plural types of media (for example, texts, graphics, audio files, and videos). The e-mail may also be received and transmitted using an independent e-mail application independent from the web browser.

In general, a user may need to customize a multimedia attachment. For example, a user may desire extracting only audio from a video clip, or to translate the audio from one language to the user's own language.

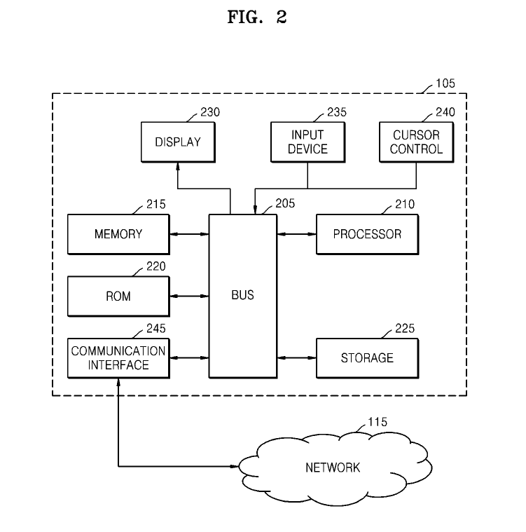

FIG. 2 is a block diagram showing an example of a computing device 105a according to an embodiment of the present disclosure.

Referring to FIG. 2, the computing device 105 includes a bus 205, a processor 210, a memory 215, a Read-Only Memory (ROM) 220, a storage 225, a display 230, an input device 235, a cursor controller 240, and a communication interface 245, but is not limited thereto.

The bus 205 is a means for communicating data between components within the computing device 105.

The processor 210, which is connected to the bus 205, processes information. In particular, the processor 210 processes instructions for customizing a multimedia attachment within an e-mail according to an embodiment of the present disclosure. In particular, in the current embodiment, the processor 210 processes instructions to provide an icon, via which a user's request for customizing a multimedia attachment within an e-mail, to an e-mail window user interface, instructions to receive the user's request for customizing the multimedia attachment from the user via the icon, and instructions to customize the multimedia attachment in response to the request. The icon provided to the e-mail window user interface may be provided to a toolbar of a web browser, a received e-mail displayed on the e-mail window user interface, or a user interface of an e-mail application independent from a web browser.

The memory 215 (for example, Random Access Memory (RAM) or another dynamic storage device) which is connected to the bus 205 stores instructions and information which are to be executed by the processor 210. The memory 215 may be used to store a temporary variable or other pieces of intermediate information during the execution of instructions.

The ROM 220 connected to the bus 205 stores instructions and static information for the processor 210.

The storage 225 may be, for example, a magnetic disk and/or an optical disc, and is connected to the bus 205 in order to enable storage of information.

The display 230, which displays processed data, may be coupled to the bus 205, and includes, for example, a Cathode Ray Tube (CRT), an LED display, and an LCD display. In particular, the display 230 displays an e-mail window user interface according to an embodiment of the present disclosure.

The input device 235, in the form of a keyboard, may have alphanumeric characters and other keys and is connected to the bus 205 in order to transmit information and command selection to the processor 210.

Another type of user input device is a cursor controller 240, for example, a mouse, a trackball, or a cursor direction key for transmitting direction information and command selection to the processor 210 and controlling the movement of a cursor on the display 230.

Various embodiments relate to the use of the computing device 105 in order to implement a technique described in this specification. In some various embodiments, the computing device 105 performs the technique when instructions included in the memory 215 are executed by the processor 210. The instructions may be read from another machine readable medium (for example, the storage 225) to the memory 215. The processor 210 performs process operations that are described in this specification, by the execution of the instructions included in the memory 215.

In some various embodiments, the processor 210 may include one or more processing units that execute one or more functions of the processor 210. The processing unit may be replaced with software instructions to perform a specific function or may be a hardware circuit used in combination with the software instruction. The processing unit may be referred to as a module.

The term “machine readable medium” used herein refers to all media that are used to provide data so that a machine performs a specific function. In an embodiment implemented by using the computing device 105a, various machine readable media may be used to provide instructions to the processor 210 for execution, for example. The machine readable medium may be a volatile or non-volatile storage medium. The volatile medium includes, for example, a dynamic memory such as the memory 215. The non-volatile medium includes, for example, an optical disc or a magnetic disk such as the storage 225. The media needs to be tangible so that a physical mechanism of reading instructions in a machine may detect instructions included in the media.

Typical examples of the machine readable medium include a floppy disk, a flexible disk, a hard disk, a magnetic tape or other magnetic media, a CD-ROM or other optical media, a punch card, a paper tape, other physical media including patterns of holes, a Random-Access Memory (RAM), a Programmable Read Only Memory (PROM), an Erasable Programmable Read Only Memory (EPROM), a FLASH-EPROM, other memory chips, or a cartridge.

The computing device 105 further includes a communication interface 245 connected to the bus 205. The communication interface 245 provides bidirectional data communication that connects the computing device 105 to the web server 110 through the network 110. For example, the communication interface 245 may be an Integrated Services Digital Network (ISDN) card or a modem for providing a data communication connection to a corresponding type of telephone line. Alternatively, the communication interface 245 may be a LAN card for providing a data communication connection to a compatible LAN. In all the various embodiments, the communication interface 245 transmits and receives an electrical signal, an electromagnetic signal, or an optical signal, and these signals carry a digital data stream including various types of information.

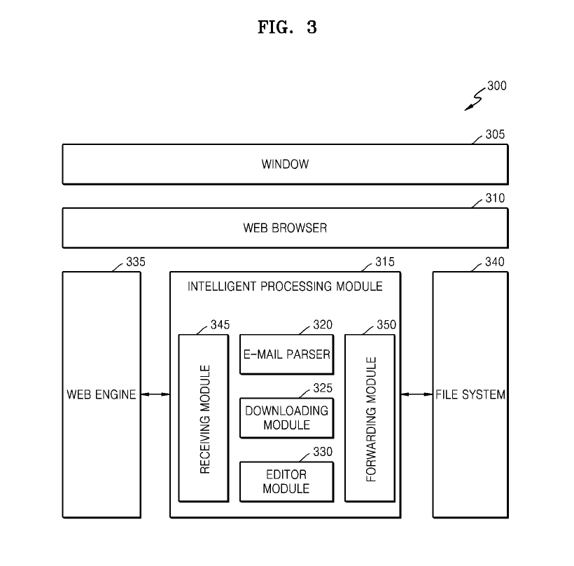

FIG. 3 is a diagram illustrating a module which is executed in a processor for customizing a multimedia attachment within an e-mail according to an embodiment of the present disclosure.

Referring to FIG. 3, a module 300 includes a window 305, a web browser 310, a web engine 335, an intelligent processing module 315, and a file system 340, but is not limited thereto.

A user may view an e-mail via a website and the window 305. In general, the e-mail includes a multimedia attachment.

The web browser 310 refers to an application program that is used to access information via the Internet. General functions of the web browser 310 include a function of opening a web page, a function of providing a list of recently visited and favorite URL addresses, and a function of storing a web page. A web browser such as Microsoft Internet Explorer™, Mozilla Firefox™, and Netscape™ is a software application via which a user may browse the Internet. A web browser extension provides an attachment editor icon to the e-mail window user interface, in response to a user's request for customizing a multimedia attachment within an e-mail. In this specification, the e-mail window user interface inclusively means a user interface which is displayed by an e-mail application, and the e-mail window user interface includes a portion that displays a web browser toolbar and an individual e-mail. The attachment editor icon according to the current embodiment may be provided to the web browser toolbar or the individual e-mail. Alternatively, the attachment editor icon may be provided to a web browser and a user interface which is displayed by an e-mail application independent from a web browser.

The web engine 335 is a software component that fetches markup contents such as HTML code, XML code, or an image file and format information such as a CSS or XSL style sheet and displays the formatted contents on a screen. The web engine 335 renders contents in a monitor or a content region of a window of a printer. The web engine 335 is generally embedded in a web browser, an e-mail client, an e-book reader, or the like which display web contents.

The intelligent processing module 315, which customizes a multimedia attachment according to user's preference, includes a receiving module 345, an e-mail parser 320, a downloading module 325, an editor module 330, and a forwarding module 350.

The receiving module 345 receives one or more e-mails through a web browser. In general, the e-mail includes one or more multimedia attachments (for example, file1.mp4 and file2.mp4).

The e-mail parser 320 parses information in an e-mail opened within a web browser window. As a result, the e-mail parser 320 identifies an opened e-mail including a multimedia attachment in an inbox. In general, the multimedia attachment includes a video file. In some implementation examples, a plurality of multimedia attachments may be attached to a single e-mail. In addition, a plurality of e-mails each including a multimedia attachment are input to the downloading module 325.

The downloading module 325, connected to an e-mail server, downloads a multimedia attachment. Thereafter, the multimedia attachment is stored in a temporary location of a memory. A user may use the editor module 330 to edit a multimedia attachment. Further, the editor module 330 extracts audio data from a multimedia attachment and may perform other customization based on a user's preference. The other customization includes translation of audio data into a user's specific language (for example, from English to Hindi), reattachment of the translated audio file to a video file, and selection of a specific video clip. The extracted audio data is input to the editor module 330 again in order to translate the audio data from one language to the user's specific language. After the customization is performed, the multimedia attachment is reattached to the e-mail. Finally, the forwarding module 350 transmits the e-mail to a desired addressee.

Various forms of the customization include audio extraction, audio translation, attachment of a translated audio to a video, downloading of a selected portion of a video, and attaching of contents after customization to another e-mail, but the present disclosure is not limited thereto. Further, the intelligent processing module 315 is autonomous, and thus removes the need for individual modules to perform the forms of customization.

The file system 340 is a type of data storage, and the data storage may be used to store, explore, and update a set of files. A general file system includes a New Technology File System (NTFS) and a File Allocation Table (FAT).

In addition, the web engine 335, the intelligent processing module 315, and the file system 340 are connected to each other and may communicate with each other.

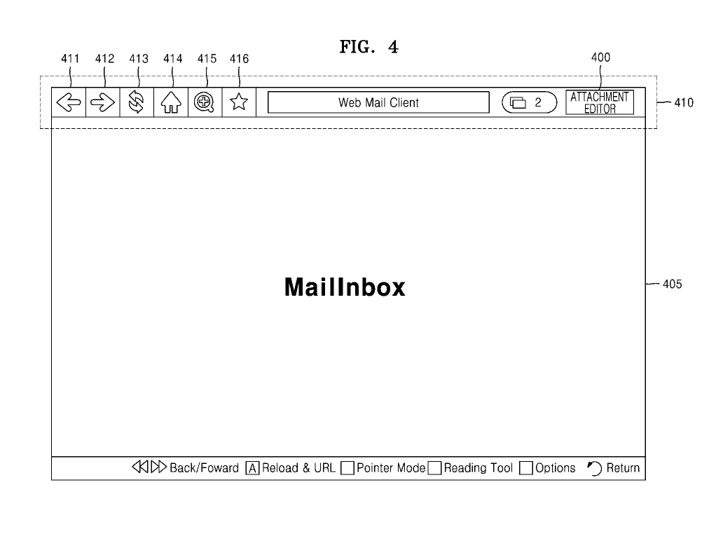

FIG. 4 is a diagram showing icons that are provided in a software toolbar of a web browser application so as to receive a request for customizing a multimedia attachment, according to an embodiment of the present disclosure.

Referring to FIG. 4, a web browser extension is a program that extends the functionality of a web browser by using various methods. The web browser toolbar is a toolbar which remains visible in a browser window. Most web browsers support the development of a browser toolbar as one method for extending a graphic user interface and the functionality of a browser. The browser toolbar may be considered as a specific type of a browser extension that provides a toolbar.

A user may desire to keep in touch with friends via e-mail, and keeps in touch with friends by using a web-based e-mail client such as Yahoo™ mail, Outlook™, and Gmail™. As a result, a user opens a web browser window 405 in order to view an e-mail in an e-mail inbox. The web browser window 405 includes a software toolbar 410 in order to perform common functions through a set of icons (also referred to as buttons). An icon may be referred to as a menu, a button, an item, or the like, and receives a user's input in order to realize a specific function. Well known icons in the software toolbar 410 include a back icon 411, a next icon 412, a refresh icon 413, a home icon 414, a contact addition icon 415, and a preference contact icon 416. In particular, according to the current embodiment, an attachment editor icon 400, which receives a request for customizing a multimedia attachment within an e-mail from a user, may be used in the software toolbar 410. When the user clicks the attachment editor icon 400, a list of customizations that may be performed with respect to the multimedia attachment is displayed. The user may select a proper type of customization from the list.

In some various embodiments, the attachment editor icon 400 may be based on a browser extension integrated in a web browser. Alternatively, the attachment editor icon 400 may be based on a plug-in integrated in the web browser.

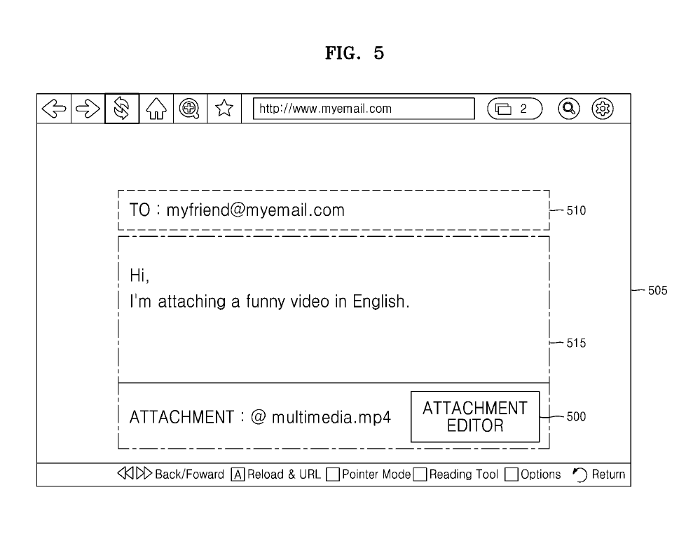

FIG. 5 is a diagram showing icons that are provided in a web mail user interface so as to receive a request for customizing a multimedia attachment, according to another embodiment of the present disclosure.

Referring to FIG. 5, web mail or web-based e-mail refers to an e-mail client implemented as a web application that may be accessed through a web browser. For example, a web mail user interface (e-mail web page) such as a web page of Gmail™ is a standard e-mail client web page which is provided by a service provider. The application is opened in a standard web browser.

The embodiment of the present disclosure is implemented by the web mail user interface 505. The web mail user interface 505 displays an e-mail message which is transmitted to a desired addressee. Typically, the e-mail message includes a message header 510 and a message body 515. The message header 510 includes control information regarding an e-mail address of an addresser and an address of one or more addressee. In addition, the message body 515 includes a text body of a message. In addition, a user may add a multimedia attachment via the message body 515. An attachment editor icon 500, which receives a request for customizing a multimedia attachment, is provided to the message body 515. When the user clicks the attachment editor icon 500, a list of different types of customizations is displayed to the user. Thereafter, the user selects any type of customization which is required to be performed on the multimedia attachment.

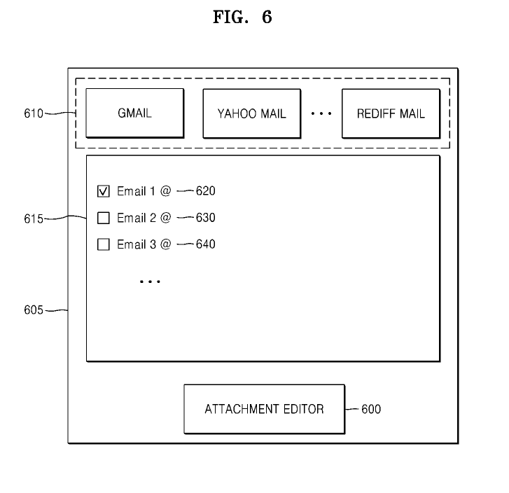

FIG. 6 is a diagram showing icons that are provided in a web-based e-mail client application via which a request may be received for customizing a multimedia attachment according to another embodiment of the present disclosure.

Referring to FIG. 6, the web-based e-mail client application transmits and receives an e-mail by using a program installed on a user computing device and is generally referred to as a widget or an app. The term “web-based e-mail client” is derived from these systems and is based on a client-server structure. In addition, the web-based e-mail client application is an independent application which is executed without a web browser.

A web browser window 605 displays e-mails received from a plurality of e-mail clients 610 such as Gmail™, Yahoo™ mail, and Rediff™ mail. All e-mails are collectively displayed to a user in an e-mail body 615, and the e-mail includes, for example, a multimedia attachment such as Email1 @ 620, Email2@ 630, and Email3@ 640. In particular, the attachment editor icon 600, which receives a request for customizing a multimedia attachment, is displayed as a button below the e-mail. When a user clicks the attachment editor icon 600, a list of different types of customizations is displayed to the user. Thereafter, the user selects a desired type of customization which is required to be performed on the multimedia attachment.

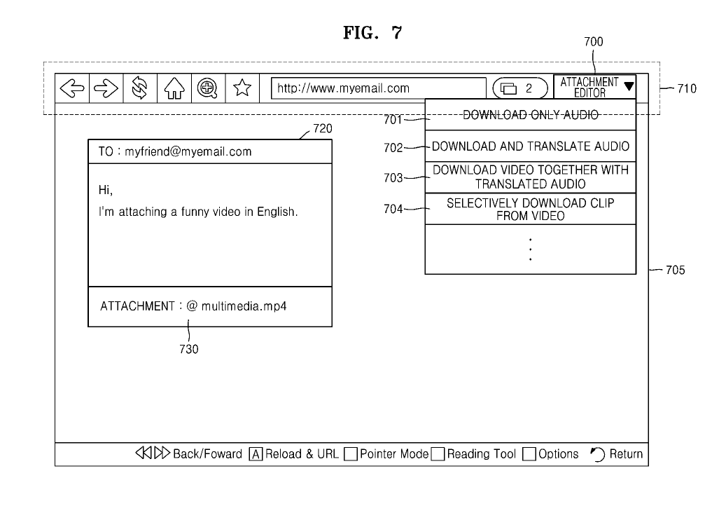

FIG. 7 is a block diagram showing an attachment editor menu of a software toolbar within a web browser application, according to an embodiment of the present disclosure.

Referring to FIG. 7, when a user accesses a website (for example, http://www.myemail.com), a corresponding web browser window 705 is opened. The web browser window 705 includes a software toolbar 710 that performs a general function. Further, in addition to many icons that are generally displayed in the software toolbar 710, the software toolbar 710 includes an attachment editor icon 700. A scenario is considered in which a user receives an e-mail including a multimedia attachment and opens the e-mail in a web browser. When the user clicks the attachment editor icon 700, menus 701, 702, 703, and 704 representative of various customizations that may be performed with respect to the multimedia attachment are opened. The customization includes the following, but is not limited thereto.

a) download only audio 701: Only audio file of video clip is downloaded.

b) download and translate audio 702: Audio file of video clip is downloaded and then translated into user's specific language.

c) download video together with translated audio 703: Video file is downloaded, audio is separated from the file, the audio is translated into user's specific language, and the translated audio is combined with the video file. Video including the translated audio is stored in temporary location.

d) selectively download clip from video 704: Specific portion in video clip is downloaded.

After the menus 701 to 704 are displayed, a user may select any customization which is required to be performed with respect to a multimedia attachment multimedia.mp4 730 attached to an e-mail 720.

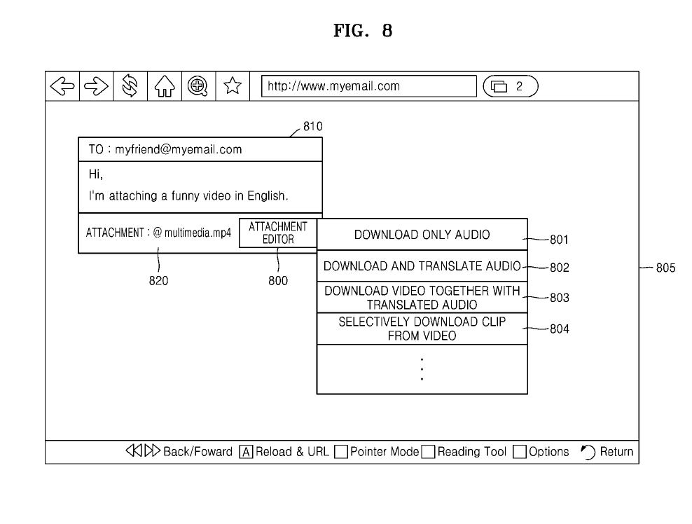

FIG. 8 is a block diagram showing an attachment editor menu of a web mail user interface according to another embodiment of the present disclosure.

Referring to FIG. 8, in a case of a web mail user interface (e-mail page), an e-mail account is accessed via a web page (for example, http://www.myemail.com). A user opens a received e-mail in a web browser window 805. In addition, the user clicks an attachment editor icon 800. Thereafter, as described above with reference to menus 701, 702, 703, and 704 of FIG. 7, menus 801, 802, 803, and 804 including various customizations that may be selected by the user are displayed to the user. After the menus 801 to 804 are displayed, the user may select any customization to be performed on a multimedia attachment multimedia.mp4 820 attached to an e-mail 810.

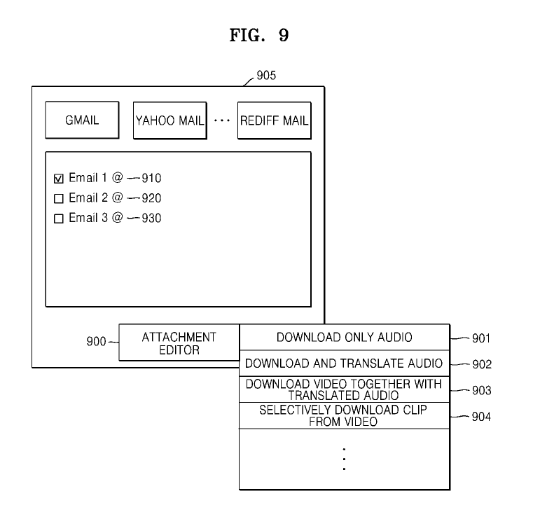

FIG. 9 is a block diagram showing an attachment editor menu of a web-based e-mail client application according to another embodiment of the present disclosure.

Referring to FIG. 9, the web-based e-mail client application displays a web browser window 905 via which a user may view e-mails provided by a plurality of clients. When the user clicks an attachment editor icon 900, menus 901, 902, 903, and 904, including various customizations that may be selected by the user and performed on a multimedia attachment, are displayed to the user, as described above with reference to FIG. 7. After the menus 901 to 904 are displayed, the user may select one desired e-mail 910 among a plurality of e-mails 910, 920, and 930 and may select any customization which is required to be performed with respect to a multimedia attachment attached to the e-mail 910.

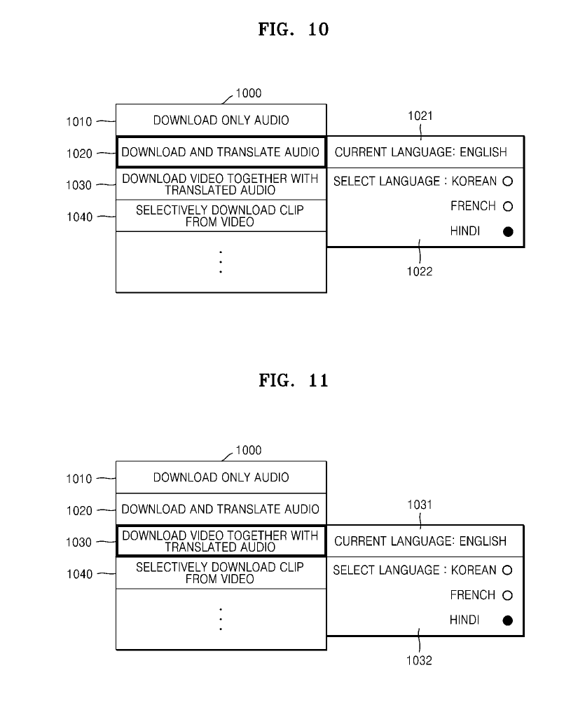

FIG. 10 is a block diagram showing an audio downloading and translation menu according to an embodiment of the present disclosure.

Referring to FIG. 10, an attachment editor menu 1000 displays various options 1010, 1020, 1030, and 1040 for customizing a multimedia attachment. A scenario is considered in which a user selects the audio downloading and translation option 1020. When the user selects the audio downloading and translation option 1020, information 1021 for notifying a current language utilized in the multimedia attachment and a list menu 1022 for allowing a language to be translated to be selected, are displayed as sub-menus. The user selects one of displayed languages. As a result, an audio file in a current language is translated to the selected language. In one example, the current language of a video clip is “English”. The user desires to translate the audio thereof, and accordingly selects “Hindi” from the list of languages. As a result, the audio file is downloaded to a temporary location and is then translated into “Hindi”.

FIG. 11 is a block diagram showing a menu for downloading a video including a translated audio according to an embodiment of the present disclosure.

Referring to FIG. 11, the attachment editor menu 1000 displays the various options 1010, 1020, 1030, and 1040 for customizing a multimedia attachment. A scenario is considered in which a user selects the option 1030 for downloading a video together with a translated audio. When the user selects the option 1030 for downloading a video together with a translated audio, information 1031 for notifying a current language utilized in the multimedia attachment and a list menu 1032 that allows a language to be translated to be selected are displayed, as sub-menus. As described above with reference to FIG. 10, a current language of audio is translated into a user's specific language. Thereafter, original audio in a video clip is replaced with the translated audio. At this point, a video clip including the translated audio is downloaded.

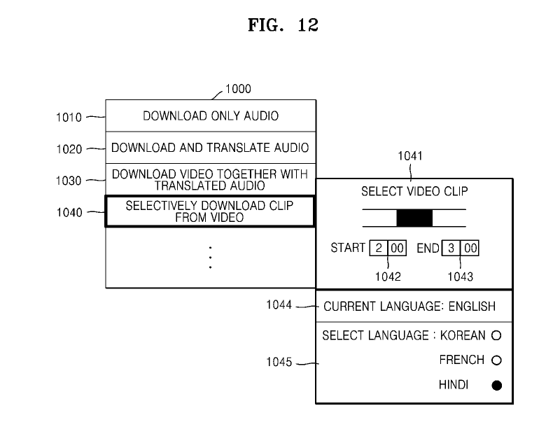

FIG. 12 is a block diagram showing a menu 1040 for selectively downloading a clip from a video, according to an embodiment of the present disclosure.

Referring to FIG. 12, the attachment editor menu 1000 displays the various options 1010, 1020, 1030, and 1040 for customizing a multimedia attachment. When a user selects the option 1040 for selectively downloading a clip from a video, a menu 1041 via which the user may select a video clip, information 1044 for notifying the user of a current language utilized in the multimedia attachment, and a list menu 1045 that allows a language to be translated to be selected are displayed as sub-menus. In the menu 1041, the user may designate and select a starting time 1042 and an ending time 1043 of a desired portion in the video clip. In addition, as described above with reference to FIG. 11, the user may select a translation language from the list of languages.

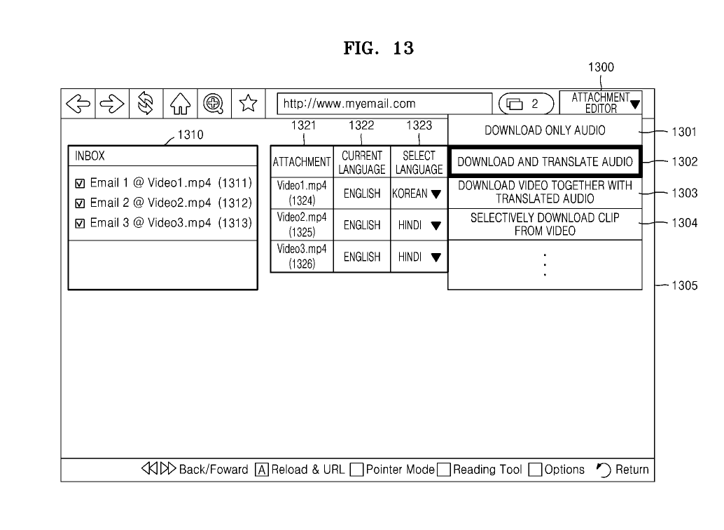

FIG. 13 is a block diagram showing a multi-attachment editor menu, according to an embodiment of the present disclosure.

Referring to FIG. 13, the customization of a multimedia attachment may be implemented with respect to two or more multimedia attachments. A web browser window 1305 displays an e-mail inbox 1310 including a plurality of e-mails each including a multimedia attachment. When a user desires to edit the respective multimedia attachments of all e-mails 1311, 1312, and 1313 that are included in the e-mail inbox 1310, the user ticks all the three e-mails and selects the attachment editor icon 1300 provided in a software toolbar. When the user selects the attachment editor icon 1300, download only audio 1301, download and translate audio 1302, download video together with translated audio 1303, and selectively download clip from video 1304 are displayed as customization options. When the user selects the audio downloading and translating option 1302, a sub-menu corresponding thereto is displayed. In the sub-menu, a first column 1321 displays video1. mp4 1324, video2.mp4 1325, and video3. mp4 1326 which are multimedia attachments of one or more e-mails selected by the user, a second column 1322 displays languages which are currently utilized in the multimedia attachments, and a third column 1323 provides an input window, corresponding to each multimedia attachment, for allowing the user to select languages into which the multimedia attachments are to be translated. In such a scenario, all video files in all current languages are simultaneously translated into user's specific languages. For example, the video1.mp4 is translated from English to Korean, the video2.mp4 is translated from English to Hindi, and the video3.mp4 is translated from English to Hindi.

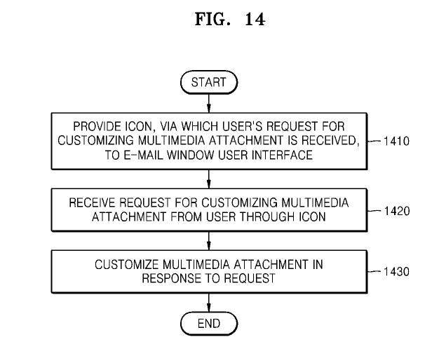

FIG. 14 is a flowchart illustrating a method of customizing a multimedia attachment of an e-mail according to an embodiment of the present disclosure.

Referring to FIG. 14, in operation 1410, a computing device provides an icon, which receives a user's request for customizing a multimedia attachment, to an e-mail window user interface. The icon may be provided to a toolbar of a web browser, a received e-mail which is displayed on the e-mail window user interface, or a user interface of an e-mail application independent from a web browser. For example, the multimedia attachment may be one or more combinations of text, audio, a still image, an animation, a video clip, and an interactive content form.

In operation 1420, the computing device receives a request for customizing the multimedia attachment from the user via the icon. For example, when the user selects the icon, the computing device provides a list, including one or more options for customizing the multimedia attachment, to the user. For example, the option list includes downloading only audio from a video clip, downloading only a video clip associated with an audio of a user's specific language, and selective downloading of the video clip, but the present disclosure is not limited thereto. The user selects the one or more options.

In operation 1430, the computing device customizes the multimedia attachment in response to the request.

In one example, according to the selection of the option for downloading only audio of a user's specific language from the video clip, the computing device provides information regarding a current language of audio within the video file of the multimedia attachment to a user, and receives information regarding a user's specific language into which the user desires the audio to be translated.

In another example, the computing device may receive a user's input for selecting one or more e-mails among e-mails included in an e-mail inbox folder, and may simultaneously customize multimedia attachments of the one or more e-mails that are selected by the user's input.

In another example, the computing device may combine the customized multimedia attachments into a single multimedia file.

In another example, the computing device receives a request from the user for storing the customized multimedia attachment in a permanent location, and stores the customized multimedia attachment accordingly.

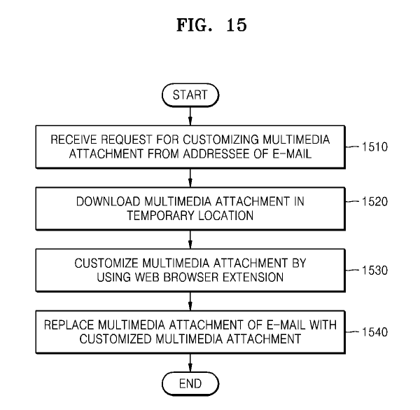

FIG. 15 is a flowchart illustrating a method of customizing a multimedia attachment of an e-mail according to another embodiment of the present disclosure.

Referring to FIG. 15, in operation 1510, a computing device receives a request for customizing a multimedia attachment from an addressee of an e-mail. The multimedia attachment includes a combination of text, audio, a still image, a video clip, and an interactive content form.

In operation 1520, the computing device downloads the multimedia attachment to a temporary location.

In operation 1530, the computing device customizes the multimedia attachment by using a web browser extension in the temporary location.

A list of options is provided to a user. The options indicate various forms of customizing the multimedia attachment. Examples of the options include downloading of only audio file from a video clip, downloading of only audio into a user's specific language from the video clip, downloading a video clip associated with an audio of the user's specific language, and downloading of the selected video clip, but the present disclosure is not limited thereto.

In addition, a current language of audio within a video file is identified. Here, the video file is a multimedia attachment. The audio in a current language is translated into a user's specific language and is then reattached to the video file.

Further, a plurality of multimedia attachments may be simultaneously customized. In such a scenario, a list of all the multimedia attachments is generated. The multimedia attachments are obtained from all e-mails of an inbox folder. Thereafter, the plurality of multimedia attachments are selected, and finally, the multimedia attachments are simultaneously customized. The selected multimedia attachments are combined into a single multimedia file.

Thereafter, the customized multimedia attachments are stored in a target location. Occasionally, a user requests to store the customized multimedia attachment in a permanent location.

In operation 1540, the computing device replaces a multimedia attachment of an e-mail with the customized multimedia attachment.

The user may transmit the e-mail including the customized multimedia attachment to a plurality of addressees.

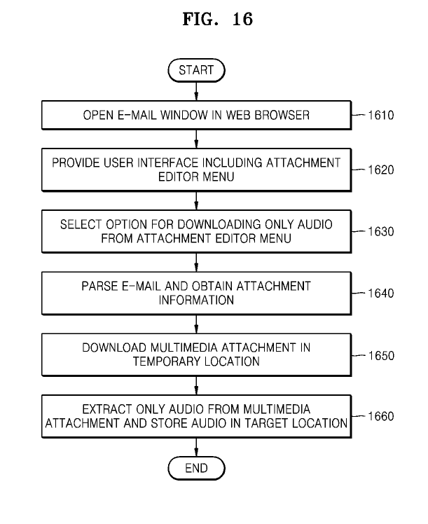

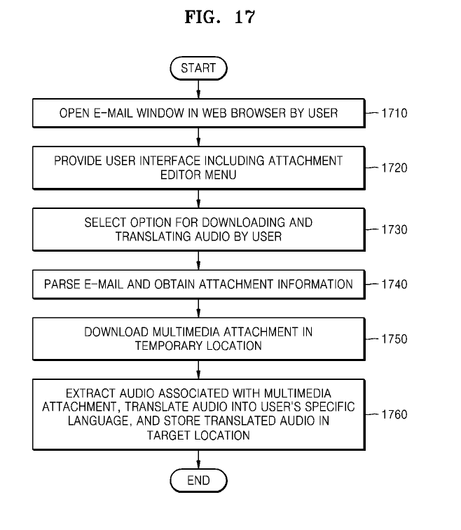

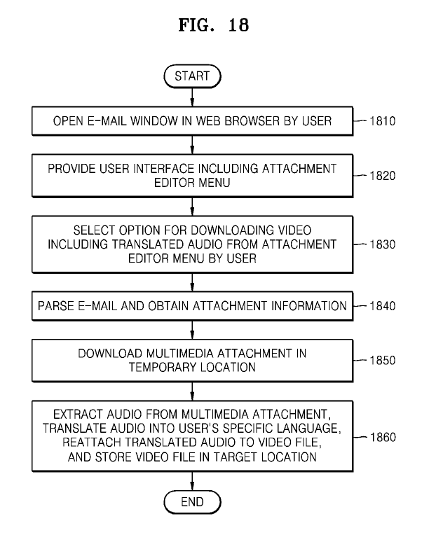

FIG. 16 is a flowchart illustrating a method of extracting only audio from a multimedia attachment according to an embodiment of the present disclosure.

Referring to FIG. 16, in operation 1610, a user desires to keep in touch with friends via e-mail, and thus the user opens an e-mail window in a web browser (for example, Google Chrome™, Firefox™, or Internet Explorer™). The user frequently receives an e-mail having a multimedia attachment. The multimedia attachment includes a combination of text, audio, a still image, a video clip, and an interactive content form.

In operation 1620, a computing device provides a user interface including an attachment editor menu. The user may often desire to edit multimedia attachments included in e-mails. Accordingly, the user clicks the attachment editor menu that may be accessed in the e-mail window and customizes the multimedia attachment. The attachment editor menu provides a list of options indicating various forms for customizing the multimedia attachment to the user.

In operation 1630, the user selects an option for downloading only audio from the attachment editor menu.

In operation 1640, the computing device parses the e-mail in order to obtain attachment information of an e-mail included in an inbox. The e-mail inbox may include a plurality of e-mails that are collected over a certain period of time. Accordingly, it may be necessary to parse the e-mail inbox in order to identify an e-mail including a multimedia attachment.

In operation 1650, the computing device downloads the multimedia attachment to a temporary location.

In operation 1660, the computing device extracts audio from the multimedia attachment and stores the audio in a temporary location. Consequently, the user may customize the multimedia attachment as he or she desires.

After the customization, the multimedia attachment is stored in a target location, and is attached to the original e-mail later. Consequently, the user may transmit the e-mail including the customized attachment to a desired addressee.

In some various embodiments, a request for storing a customized multimedia attachment in a permanent location is received from a user.

FIG. 17 is a flowchart illustrating a method of extracting and translating audio of a multimedia attachment according to an embodiment of the present disclosure.

Referring to FIG. 17, in operation 1710, a user opens an e-mail window in a web browser.

In operation 1720, a computing device provides a user interface including an attachment editor menu.

In operation 1730, the user selects an option for downloading and translating audio. The user easily translates the audio into a user's specific language by using the option.

In operation 1740, the computing device performs parsing in order to retrieve an e-mail of an e-mail inbox which includes a multimedia attachment and obtains attachment information.

In operation 1750, the computing device downloads the multimedia attachment to a temporary location.

In operation 1760, the computing device extracts audio associated with the multimedia attachment and translates the audio into a user's specific language. In addition, the audio is stored in a target location.

Audio of a video file is clearly defined as being associated with a current language (for example, English). Accordingly, the audio associated with the current language is identified in the video file and is extracted.

Consequently, audio is translated from the current language into a user's specific language. The translated audio is attached to the video file, and is used to transmit an e-mail including a customized video to a desired addressee. In some various embodiments, the user may utilize the translated audio for individual needs.

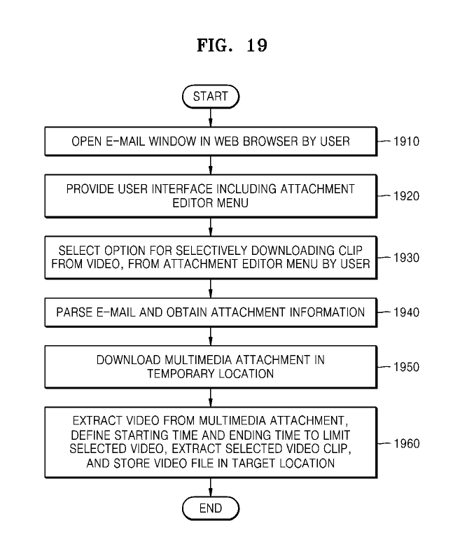

FIG. 18 is a flowchart illustrating a method of downloading a video, including a translated audio, from a multimedia attachment according to an embodiment of the present disclosure.

Referring to FIG. 18, in operation 1810, a user opens an e-mail window in a web browser.

In operation 1820, a computing device provides a user interface including an attachment editor menu.

In operation 1830, the user selects an option for downloading a video, including a translated audio, from an attachment editor menu.

In operation 1840, the user desires to customize a specific multimedia attachment, and thus the computing device performs parsing in order to obtain attachment information of an e-mail and then obtains the attachment information.

In operation 1850, the computing device downloads the multimedia attachment, that is, a video, to a temporary location.

In operation 1860, the computing device performs a series of actions to customize the downloaded media attachment. First of all, audio is extracted from the multimedia attachment. In short, the audio translated into audio associated with a user's specific language, which is then attached to a video file. The video file is stored in a target location. A user may use the option to download a specific video file having a translated audio.

FIG. 19 is a flowchart illustrating a method of extracting only a selected clip from a multimedia attachment according to an embodiment of the present disclosure.

Referring to FIG. 19, in operation 1910, a user opens an e-mail window in a web browser.

In operation 1920, a computing device provides a user interface including an attachment editor menu.

In operation 1930, the user selects an option for downloading a selected clip from a video in the attachment editor menu.

In operation 1940, the computing device parses an e-mail and obtains attachment information.

In operation 1950, the computing device downloads the multimedia attachment to a temporary location.

In operation 1960, the computing device extracts a video from a multimedia file, and the user defines desired parts of the video, that is, a starting time and an ending time in the video, to limit the selected video, and thus a selected video clip is extracted and is stored in a target location. For example, the video in the multimedia file may be seven minutes long. The user may define the starting time and the ending time as “2:00” and “3:00”, respectively, and may select a specific part of the video. Consequently, the video starting at 2 minutes and ending at 3 minutes is selected. Eventually, the selected video clip is extracted and is stored in a target location.

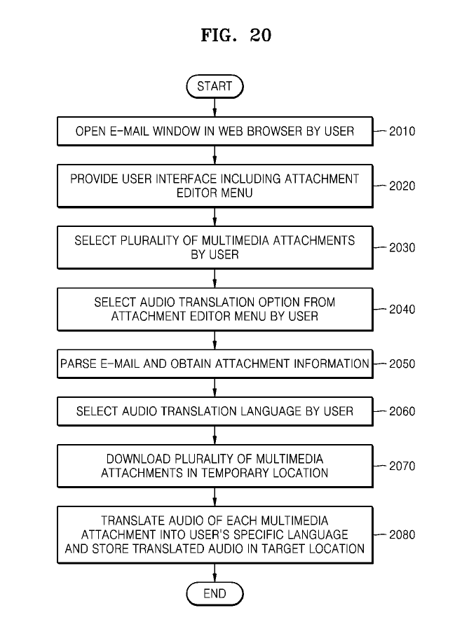

FIG. 20 is a flowchart illustrating a method of simultaneously editing a plurality of attachments in a plurality of e-mails according to an embodiment of the present disclosure.

Referring to FIG. 20, in operation 2010, a user opens an e-mail window in a web browser.

In operation 2020, a computing device provides a user interface including an attachment editor menu. A new multi attachment editor menu may be provided separately from the attachment editor menu, for a plurality of e-mail customizations.

In operation 2030, the user selects multimedia attachments of a plurality of e-mails.

In operation 2040, the user selects, for example, an audio translation option from an attachment editor menu.

In operation 2050, the computing device performs parsing in order to obtain attachment information of a plurality of e-mails.

In operation 2060, the computing device generates a list (for example, Video1.mp4, Video2.mp4, and Video3.mp4) of multimedia attachments from a plurality of e-mails within an inbox folder after e-mail parsing, and provides an input window in which the user may select a language into which audio of each multimedia attachment is to be translated. Thus, the user selects a translation language with respect to each of the multimedia attachments included in the list.

In operation 2070, the computing device downloads the plurality of multimedia attachments to a temporary location.

In operation 2080, the user translates the audio of each multimedia attachment from one language to the user's specific language and stores the translated audio in a target location.

In addition, the user may select the multimedia attachments and combine the multimedia attachments into one multimedia file. For example, the user may desire to combine a translated audio of Video1.mp4 and a translated audio of Video2.mp4 into one video file including the translated audio of Video1.mp4 and the translated audio of Video2.mp4.

Preferably, in the embodiment described in this specification, a multimedia attachment within an e-mail is immediately and efficiently customized. A system according to the present disclosure provides a method of automatically processing and editing contents of a multimedia file. A user may identify the multimedia attachment by using an intelligent system and may customize the contents. Further, the system is implemented in a web browser, and thus an additional tool for customization is not required, thereby saving resources. In addition, the system may be easily implemented using various methods such as browser plug-in, browser extension, and a web application.

The present disclosure can also be embodied as computer readable code on a computer readable recording medium. The computer readable recording medium is any data storage device that can store data which can be thereafter read by a computer system. Examples of the computer readable recording medium include ROM, RAM, CD-ROMs, magnetic tapes, floppy disks, optical data storage devices, and flash memory.

It should be understood that the various embodiments described therein should be considered in a descriptive sense only and not for purposes of limitation. Descriptions of features or aspects within each embodiment should typically be considered as available for other similar features or aspects in other various embodiments.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of customizing a multimedia attachment within an e-mail, the method comprising:
providing an icon, via which a user's request may be received for customizing the multimedia attachment, to an e-mail window user interface;
receiving the user's request for customizing the multimedia attachment from the user via the icon; and
customizing the multimedia attachment in response to receiving the user's request.

2. The method of claim 1, wherein the providing of the icon to the e-mail window user interface comprises one of providing the icon to a toolbar of a web browser, providing the icon to a received e-mail displayed on the e-mail window user interface, and providing the icon to a user interface of an e-mail application independent from the web browser.

3. The method of claim 1, wherein the multimedia attachment comprises at least one combination of text, audio, a still image, an animation, a video clip, and an interactive content form.

4. The method of claim 1, wherein the customizing of the multimedia attachment comprises:
providing a list including at least one option for customizing the multimedia attachment to a user; and
receiving a user input selecting the at least one option.

5. The method of claim 4, wherein the at least one option comprises one of downloading only audio from a video clip of the multimedia attachment, downloading only audio of a user's specific language from the video clip, downloading a video clip associated with the audio of the user's specific language, and selectively downloading a video clip.

6. The method of claim 5, further comprising:
providing information regarding a current language corresponding to audio within a video file of the multimedia attachment in response to user input selecting the at least one option for downloading only audio of the user's specific language from the video clip; and
receiving information regarding a user's specific language that a user desires to translate, from the current language.

7. The method of claim 6, further comprising
translating the audio corresponding to the current language to audio corresponding to the user's specific language, and
attaching the translated audio to the video file.

8. The method of claim 1, further comprising
receiving a user's input for selecting at least one e-mail among e-mails comprised in an e-mail inbox folder, and
simultaneously customizing multimedia attachments of the selected at least one e-mail based on the user's input.

9. The method of claim 8, further comprising combining the customized multimedia attachments into a single multimedia file.

10. The method of claim 1, wherein the customization is performed via a web browser extension.

11. The method of claim 1, further comprising receiving a request for storing the customized multimedia attachment in a permanent location, from the user.

12. A computing device that customizes a multimedia attachment within an e-mail, the computing device comprising:
a display device configured to output a user interface;
an input device configured to receive a user's input;
a communication interface configured to communicate with an external device;
a memory configured to store data processed by a processor; and
a processor configured to process the multimedia attachment within the e-mail so as to customize the multimedia attachment,
wherein the processor provides an icon, via which a user's request for customizing the multimedia attachment may be received, to an e-mail window user interface, receives the user's request for customizing the multimedia attachment from the user via the icon, and customizes the multimedia attachment in response to receiving the user's request.

13. The computing device of claim 12, wherein the icon is provided to one of a toolbar of a web browser, a received e-mail displayed on the e-mail window user interface, and a user interface of an e-mail application independent from the web browser.

14. The computing device of claim 12, wherein, in order to customize the multimedia attachment, the processor is further configured to provide at least one option for customizing the multimedia attachment to a user, and receive a user input selecting the at least one option from the user.

15. The computing device of claim 14, wherein the at least one option comprises one of downloading only audio from a video clip of the multimedia attachment, downloading only audio of a user's specific language from the video clip, downloading a video clip associated with the audio of the user's specific language, and selectively downloading a video clip.

16. The computing device of claim 15, wherein the processor is further configured to provide information regarding a current language corresponding to audio within a video file of the multimedia attachment in response to user input selecting the at least one option for downloading only audio of the user's specific language from the video clip, and to receive information regarding a user's specific language that a user desires to translate, from the current language.

17. The computing device of claim 16, wherein the processor is further configured to translate the audio corresponding to the current language to audio corresponding to the user's specific language and to attach the translated audio to the video file.

18. The computing device of claim 12, wherein the processor is further configured to receive a user's input for selecting at least one e-mail among e-mails comprised in an e-mail inbox folder, and to simultaneously customize multimedia attachments of the selected at least one e-mail based on the user's input.

19. The computing device of claim 12, wherein the processor is further configured to perform the customization via a web browser extension.

20. A non-transitory computer readable recording medium having embodied thereon a computer program, which when executed by a computer, performs a method of customizing a multimedia attachment within an e-mail, the method comprising:
providing an icon, via which a user's request for customizing the multimedia attachment is received, to an e-mail window user interface;
receiving the user's request for customizing the multimedia attachment from the user via the icon; and
customizing the multimedia attachment in response to receiving the user's request.
